(19) United States
(12) Patent Application Publication
(10) Pub. No.: US 2005/0098493 A1
(43) Pub. Date: May 12, 2005

(54) Water filter

(76) Inventor: Michael Danner, Islandia, NY (US)

Correspondence Address: Galgano & Burke, Suite 35, 300 Rabro Drive, Hauppauge, NY, 11788, US

(21) Appl. No.: 10/705,490

(22) Filed: Nov. 10, 2003

(51) Int. Cl. B01D 24/10

(52) U.S. Cl. 210/276; 210/278

(57) ABSTRACT

A filter assembly includes a three position valve having a diverter which directs flow through the filter in three ways: filter, rinse, and backwash. The filter also has a manually activated agitator.

### BACKGROUND OF THE INVENTION

1. Field of the Invention

The invention relates to water filters. More particularly, the invention relates to a water filter for a pond, water garden, outdoor aquarium, artificial stream, waterfall, swimming pool, or spa.

2. State of the Art

Ponds have always been a desirable landscaping feature, particularly in conjunction with gardens. Until recently, however, artificial ponds have been relatively expensive to construct. With the advent of fish-safe polymer liner material that can be formed into any convenient shape, and covered with rock strata, natural looking artificial ponds have become a popular landscape feature.

Both natural and artificial ponds require maintenance in order to remain aesthetically pleasing. Ponds should also provide a habitat not only for fish but other creatures such as birds, frogs, butterflies and the like. Clear water is the feature most desired in ponds so that fish and submerged plants may be viewable. However, maintaining the clarity of the water can be difficult. Algae, in particular free swimming algae, may cause the water to become cloudy. The excessive algae typically occurs when the water contains an excess of nutrients such as ammonia and phosphorous. This ammonia and phosphorous is generally added to pond water by fish waste and fertilizer runoff from the land surrounding the pond. Although aquatic plants may consume a portion of the nutrients, the number of plants is typically insufficient to handle the amount of excessive nutrients in a pond. Algae, which feed on these nutrients, then multiply due to the abundance of nutrients. This multiplication may result in algae blooms which cause the pond water to cloud.

One method of clarifying water is to add chemicals to the water which destroy algae. However, these chemicals may destroy or have a negative impact on the number and growth of aquatic plants and fish. Also, chemicals must be replenished and this can be expensive.

With these issues in mind, several companies have looked to the art of swimming pool maintenance in an effort to design apparatus for filtering pond water and skimming the pond surface. Typical solutions based on swimming pool technology are disclosed in U.S. Pat. Nos. 5,584,991 and 6,054,045 to Wittstock et al. One of the main disadvantages of these solutions is that they require excavation and permanent installation. In many cases, these solutions must be installed when the pond is first constructed because pipes need to be laid beneath the pond. In addition, these solutions require that relatively large apparatus be arranged adjacent to the pond. These unsightly apparatus must be camouflaged with stones, shrubs, etc.

The applicant herein has looked beyond swimming pool technology to provide the Pondmaster® filter system. The applicant's Pondmaster® filter system is submersible, does not require any excavation, and does not require unsightly apparatus to be located adjacent to the pond. It is modular and can be expanded to suit ponds of different sizes.

Recently, the applicant herein has concentrated efforts on maintaining the proper level of beneficial bacteria while eliminating or minimizing the presence of harmful bacteria in the pond ecosystem. Generally speaking, certain kinds of aerobic bacteria convert ammonia into nitrites. Other kinds of aerobic bacteria convent nitrites into nitrates which aquatic plants turn into nitrogen gas. These beneficial bacteria need a surface to live on and a supply of oxygen rich water. If the beneficial aerobic bacteria do not receive oxygen rich water, harmful anaerobic bacteria will grow and emit toxins which are deadly to fish.

A good place for beneficial bacteria to live is on the surface of filter media. However, in order to assure a good supply of oxygen rich water, the filter media must be kept clean to allow the water to flow through it.

### SUMMARY OF THE INVENTION

It is therefore an object of the invention to provide a filter assembly for a pond, water garden, outdoor aquarium, artificial stream, waterfall, swimming pool, or spa.

It is also an object of the invention to provide a filter assembly which provides a good atmosphere for the growth of beneficial bacteria.

It is another object of the invention to provide a filter assembly which is easy to clean.

It is still another object of the invention to provide a filter assembly which combines several desirable features in an easy to use package.

In accord with these objects which will be discussed in detail below, the apparatus of the present invention includes a filter drum with a removable cover assembly. The filter drum contains filter media, a manually operated agitator, and an ultra violet (UV) sterilizer assembly. The agitator is coupled to the UV assembly which extends from the bottom of the drum through the cover assembly coaxial with the axis of the drum. A handle is coupled to the UV assembly on the outside of the cover assembly. Movement of the handle causes movement of the agitator which stirs up the media. A three way valve is provided for directing the flow of water received from the pond. In a first (filter) position, water flows from the pond into the annular space defined by the filter drum and the UV assembly from the top of the filter through the filter media, up inside the UV assembly and out of the valve assembly back to the pond. In a second (backwash ) position, water flows from the pond through the valve down into the UV assembly to the bottom of the filter drum, then up through the filter media in the annular space and out through the valve to the waste conduit. In a third (rinse) position, water flows from the pond in the same direction as in the filter position except it exits the valve assembly via the waste conduit for removal from the pond water. According to a presently preferred embodiment, a pressure gauge is mounted on the top of the cover to indicate when the filter needs to be backwashed. The agitator may be used in both the backwash and rinse operations.

Certain of the foregoing and related objects are also attained according to the present invention by the provision of a filter assembly comprising a container for containing filter media, and a three way valve coupled to said container, said three way valve having a water inlet, a water outlet, a waste water outlet, and a flow diverter, and said flow diverter being movable to a filter position, in which water from a body of water is fed via said water inlet through said container in a first direction to effect filtering of said water and back to said water outlet for return to said body of water, a rinse position, in which water from a body of water is fed via said water inlet through said container in said first direction to effect filtering of said water and back to said waste water outlet for removal from said body of water, and a backwash position, in which water from a body of water is fed via said water inlet through said container in a reverse direction to said first direction to effect backwashing of said filter media and back to said waste water outlet for removal from said body of water.

Preferably, the flow diverter has means for diverting water both horizontally and vertically, and a manually operable agitator is located in said container and coupled to a handle outside said container. Most desirably, a UV sterilizer is coupled to said agitator and said handle, and said flow diverter includes a discontinuous cylinder.

In a preferred embodiment, the filter assembly comprises a substantially cylindrical container for holding filter media, said container having a central axis, an agitator assembly having an axis of rotation substantially coaxial with said central axis; and a removable cover, said removable cover having a handle, said handle being coupled to said agitator for reciprocating rotating said agitator assembly about said axis of rotation thereof.

Most advantageously, the filter assembly further comprises a UV sterilizer, said UV sterilizer being arranged substantially coaxial with said central axis, and filter media disposed in said container generally above said agitator. The UV sterilizer preferably has an outer tube and an inner UV lamp defining therebetween an annular fluid flow path.

Certain of the foregoing and related objects are also attained in a three way valve for use with a water filter, said valve comprising: a water inlet, a water outlet, a waste water outlet, and a flow diverter, said flow diverter having means for diverting the flow of water both horizontally and vertically. Most desirably, the flow diverter has three fluid pathways defined by three cylinder segments and a fourth fluid pathway substantially perpendicular to the three fluid pathways.

Additional objects and advantages of the invention will become apparent to those skilled in the art upon reference to the detailed description taken in conjunction with the provided figures.

### BRIEF DESCRIPTION OF THE DRAWINGS

FIG. 1 is a longitudinal sectional view of a pond filter according to the invention;

FIG. 2 is a side elevational view of a pond filter according to the invention;

FIG. 3 is a perspective view of the cover, UV, and agitator assemblies;

FIG. 4 is a broken perspective view of a pond filter according to the invention;

FIG. 5 is a perspective view of the top of a pond filter according to the invention;

FIG. 6 is a perspective view of the underside of the cover assembly;

FIG. 7 is an enlarged perspective view of the diverter of the three way valve;

FIG. 8 is a perspective view of the underside of the cover assembly with a part removed to show the inner workings of the three way valve.

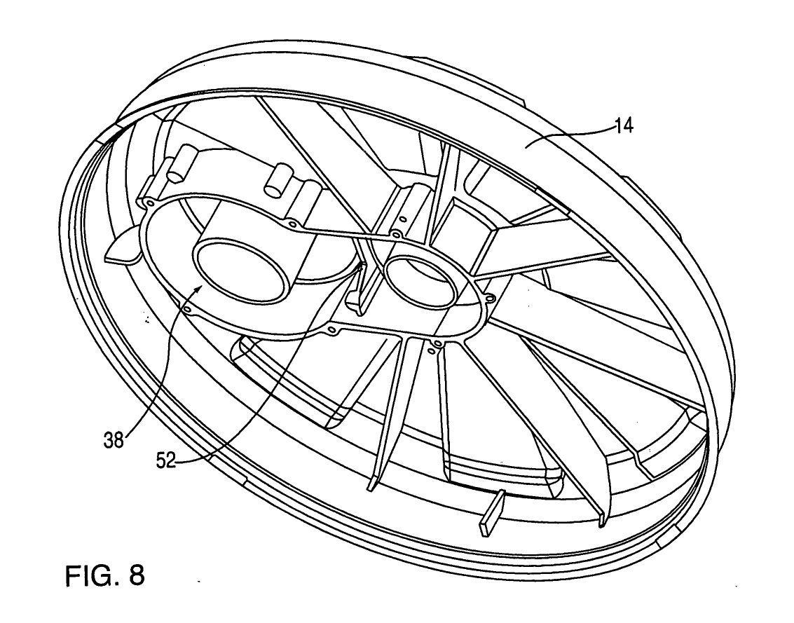

FIG. 9 is a broken perspective view of the pond filter according to the invention showing the path of pond water during the filter cycle;

FIG. 9a is a transparent perspective view of the three way valve during the filter cycle;

FIG. 10 is a broken perspective view of the pond filter according to the invention showing the path of pond water during the backwash cycle;

FIG. 10a is a transparent perspective view of the three way valve during the backwash cycle;

FIG. 11 is a broken perspective view of the pond filter according to the invention showing the path of pond water during the rinse cycle; and

FIG. 11a is a transparent perspective view of the three way valve during the rinse cycle.

### DETAILED DESCRIPTION OF THE PREFERRED AND ILLUSTRATED EMBODIMENT

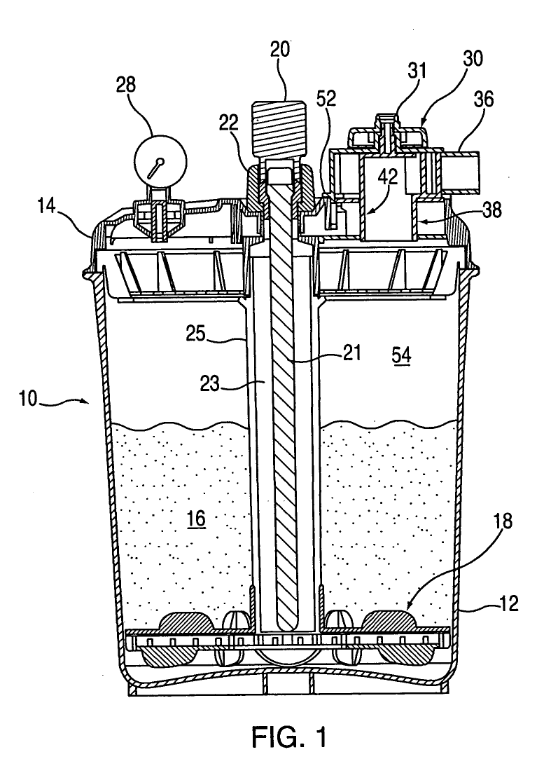

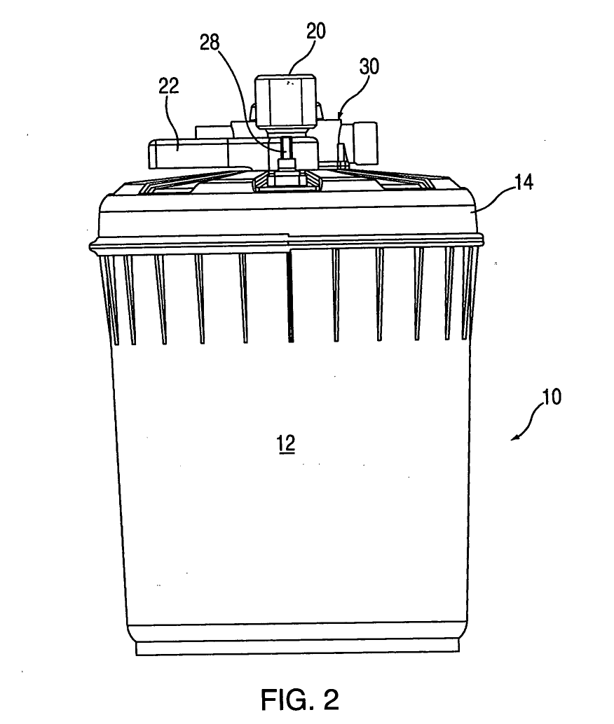

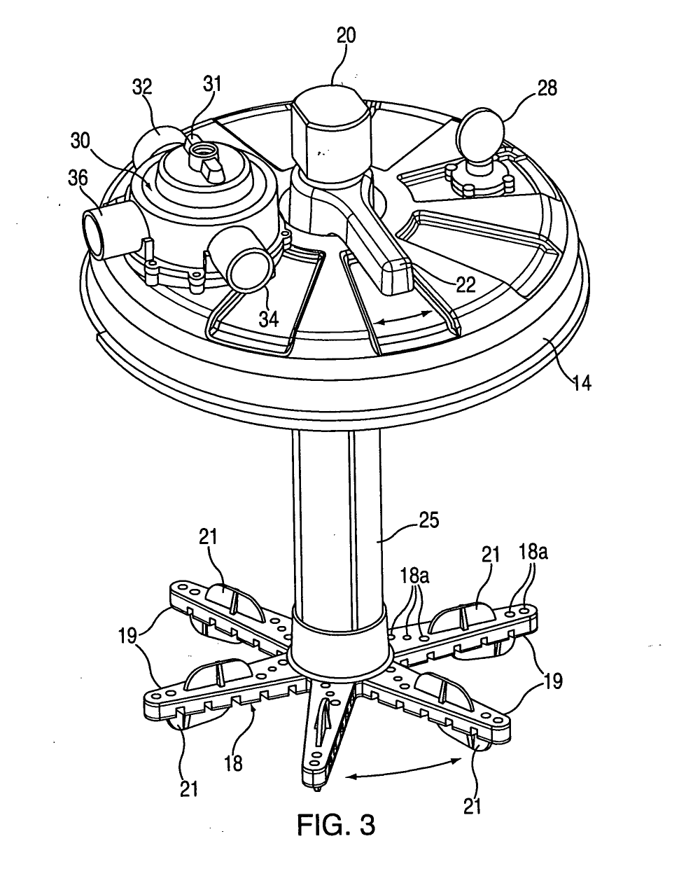

Although the filter apparatus has many applications, it will be described with reference to a pond. Turning now to the Figures generally and in particular to FIG. 1, the filter apparatus 10 of the present invention includes a filter drum 12 with a removable cover assembly 14. The filter drum 12 contains filter media 16, a manually operated agitator 18, and an ultra violet (UV) sterilizer assembly 20. The agitator 18 is coupled to the base of the UV assembly 20 which extends from the bottom of the drum 12 through the cover assembly 14 coaxial with the axis of the drum 12. A handle 22 (seen best in FIGS. 2-5) is coupled to the UV assembly 20 on the outside of the cover assembly 14. Rotary movement of the handle in a back and forth reciprocal causes movement of the agitator as illustrated in FIG. 3. The agitator assembly 18 has a plurality of radially outward extending arms 19 each of which have a plurality of upstanding and downstanding depending vanes 21. Upon rotary reciprocation of handle 22, arms 19 move back and forth and the vanes thereof shift the filter media to unclog the same.

The cover assembly 14 preferably includes an O-ring seal 24 and a releasable locking clamp (not shown) to effect sealing and locking engagement of cover assembly 14 and drum 12. A pressure gauge 28 is preferably provided on the cover to indicate the pressure of the water in the filter drum 12. The UV assembly 20 is provided at its top with an electrical connector (not shown) to supply power to the UV bulb 21.

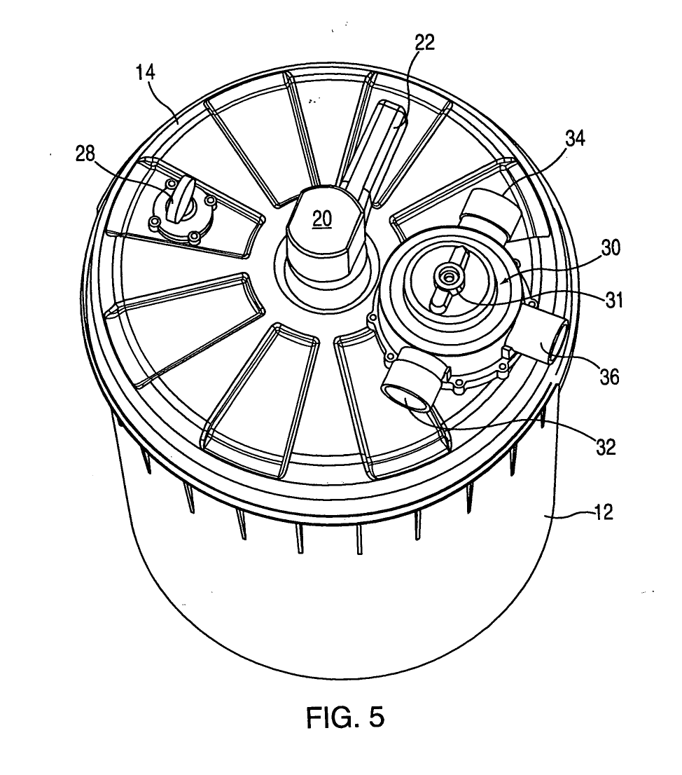

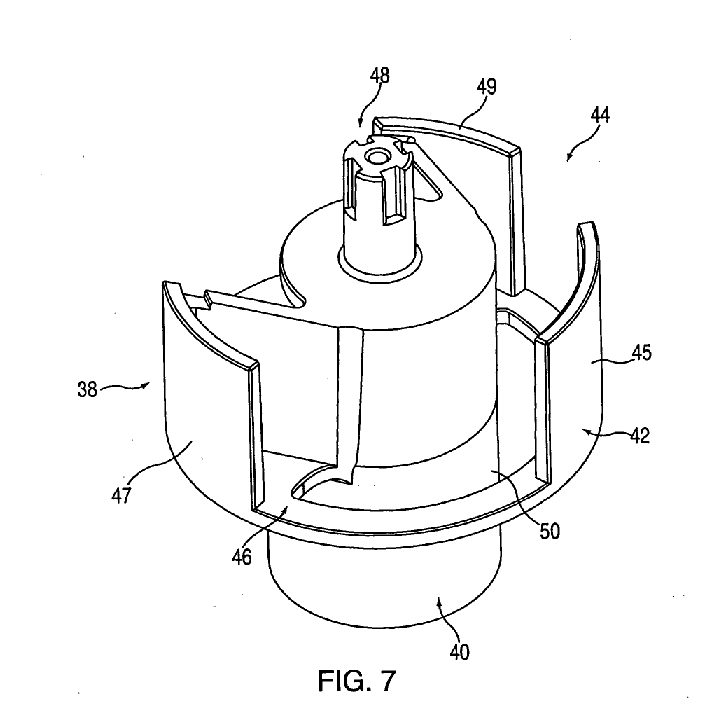

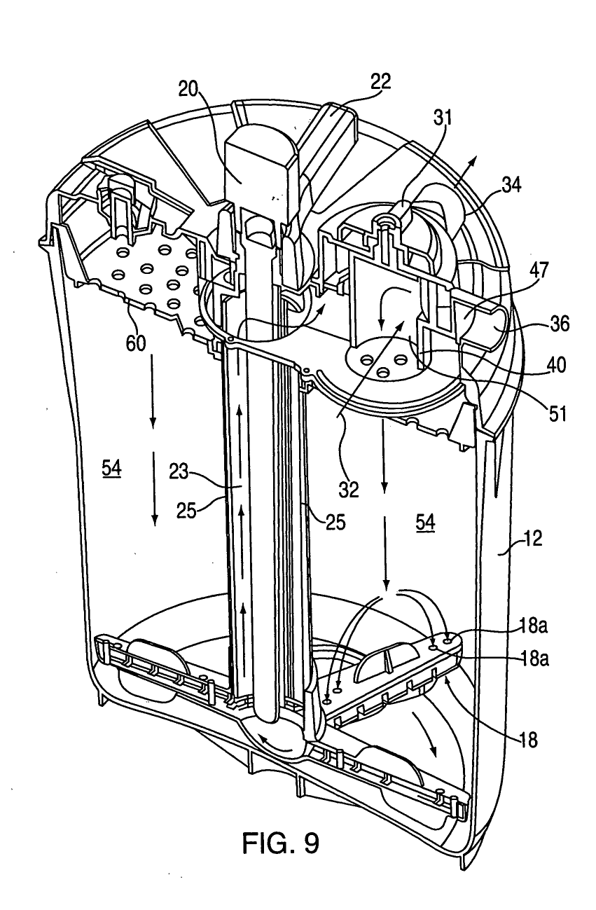

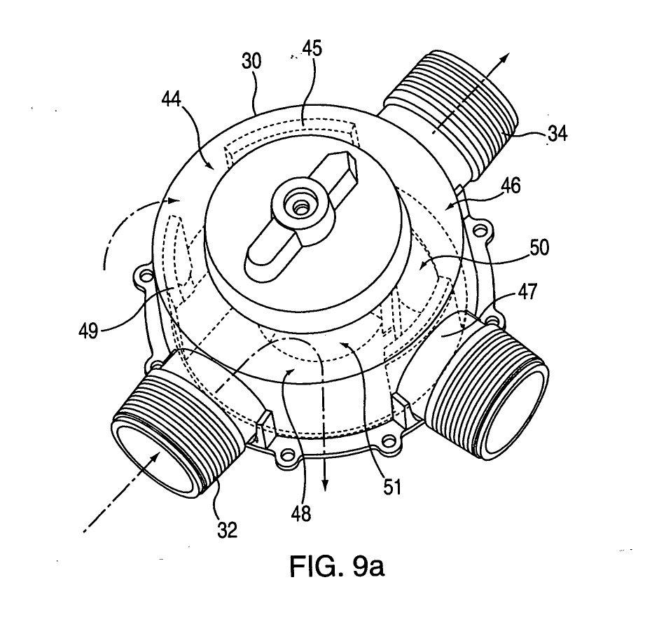

According to the invention, a three way valve 30 is provided for directing the flow of water received from the pond (not shown). As seen best in FIG. 5, the valve 30 has a pump coupling 32 for receiving water from the pond typically via a pump (not shown), a pond return coupling 34 for returning water to the pond, and a waste discharge coupling 36 for returning water to a waste water conduit (not shown). The heart of the three way valve is the diverter 38 which is shown in detail in FIG. 7. The diverter 38 has a lower continuous cylinder 40 and an upper discontinuous cylinder 42. The upper and lower cylinders are concentric but the upper discontinuous cylinder has a larger diameter. The upper cylinder 42 has three vertical discontinuities or slots 44, 46, and 48 separated by three cylinder segments 45, 47, and 49. A horizontal discontinuity or arcuate slot 50 is in fluid communication with the vertical discontinuities 44 and 46. A central opening 51 through the lower cylinder 40 is in fluid communication with discontinuity 48 (FIG. 9a). The position of the diverter is controlled by rotatable, indexing control knob 31 which is connected to diverter 30 to effect movement thereof into one of three operative positions.

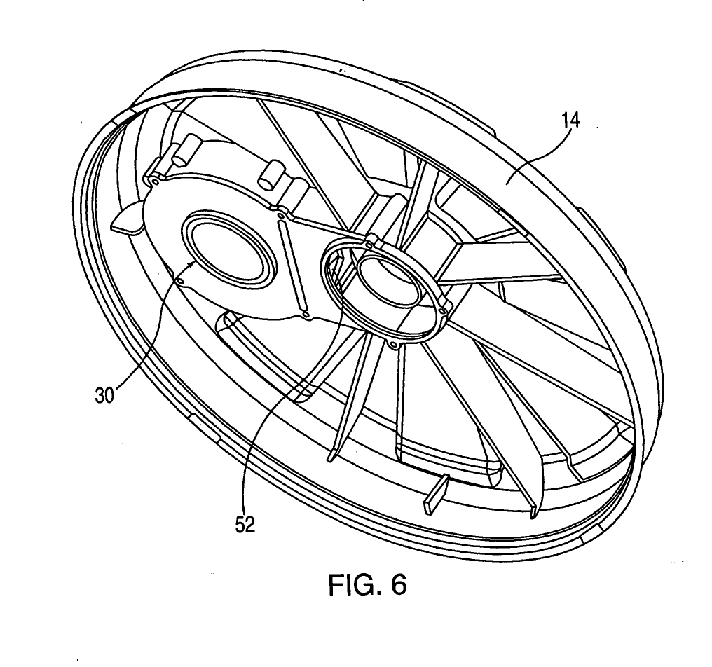

In a first (filter) position, the knob 31 positions diverter 38 such that discontinuity 48 opens onto the pump inlet 32 and cylinder segment 47 blocks the waste water discharge coupling 36. As seen best in FIGS. 9 and 9a (see arrows showing path of pond water), this diverts water from the pond (drawn via the pump) through the pump inlet 32 via diverter opening 48 and central opening 51, through perforated plate 60 and into the annular space 54 defined between the filter drum 12 and the UV assembly 20. It flows from there downwardly through the filter media 16 (not shown), and then up inside the channel of the UV assembly 20 via holes 18a in the agitator 18. More particularly, the water flows upwardly into the annular space 23 defined between the UV bulb 21 and the outer wall 25 of the UV assembly 20. The water exits the top of the UV assembly 20 and flows through a gate 52 (seen best in FIGS. 6 & 8) into the space surrounding the lower continuous cylinder 40. There it is free to move up through the slot 50 and out through discontinuity 46 into the return coupling 34.

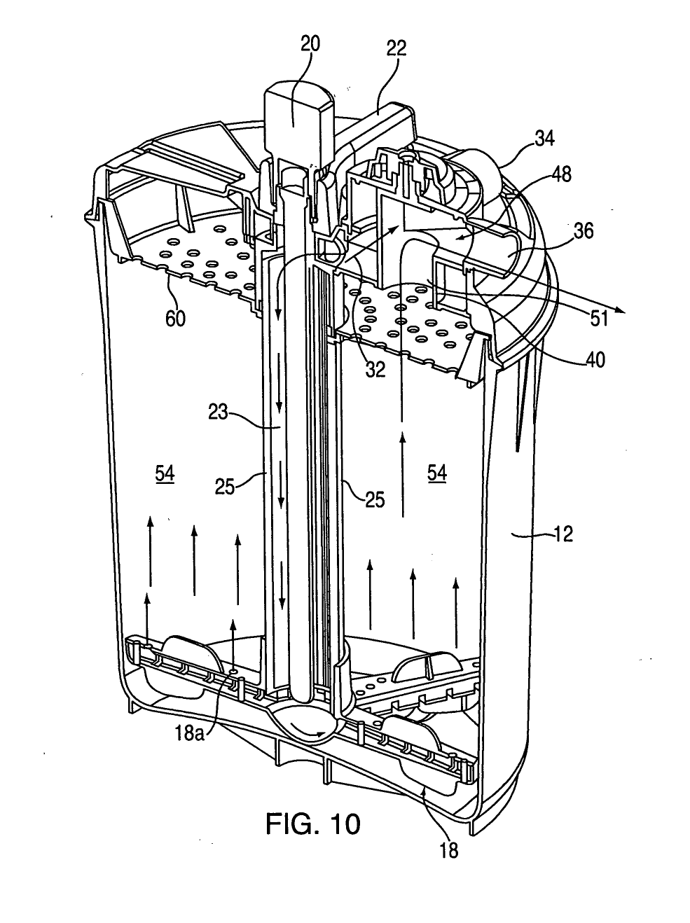

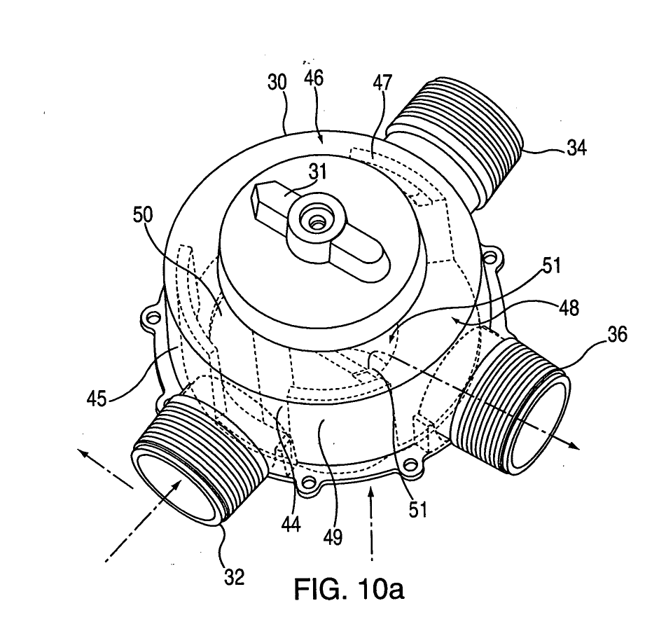

In a second (backwash) position illustrated in FIGS. 10 and 10a, the diverter 38 is rotated so that the discontinuity 44 is aligned with pump inlet 32, the cylinder segment 47 blocking the pond return coupling 34 and the discontinuity 48 is aligned with the waste water coupling 36. As shown by the arrows in FIGS. 10 and 10a, in this position water flows from the pond through the pump inlet 32 and is diverted (via the slot opening 50 and the gate 52) down into the annulus 23 of the UV assembly 20 to the bottom of the filter drum. It exits through the holes 18a in the agitator 18 then up through the filter media 16 (not shown), passes into the opening 51 in the lower continuous cylinder 40 of the diverter 38 and out through the waste water coupling 36 of the valve 30 via the discontinuity 48.

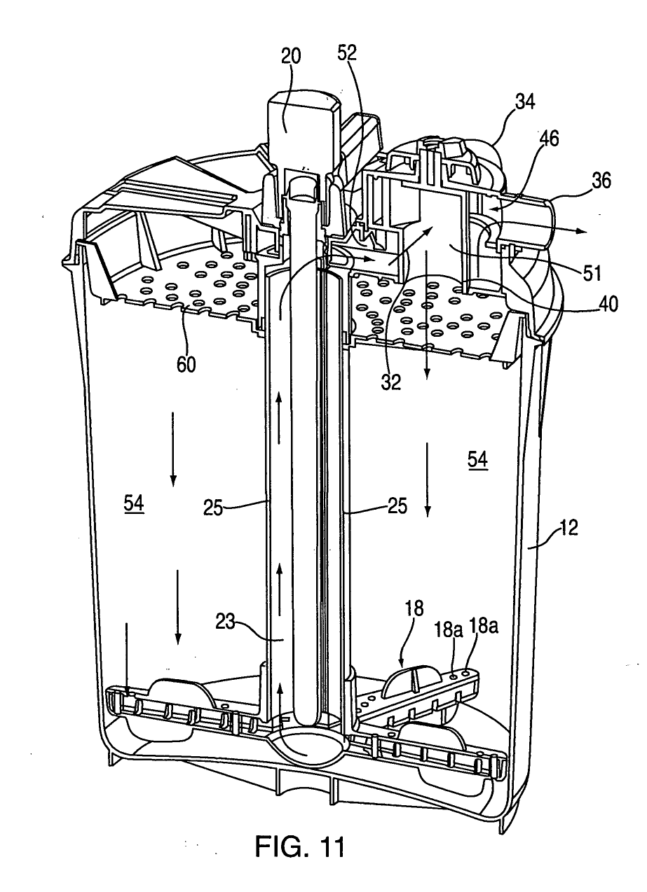

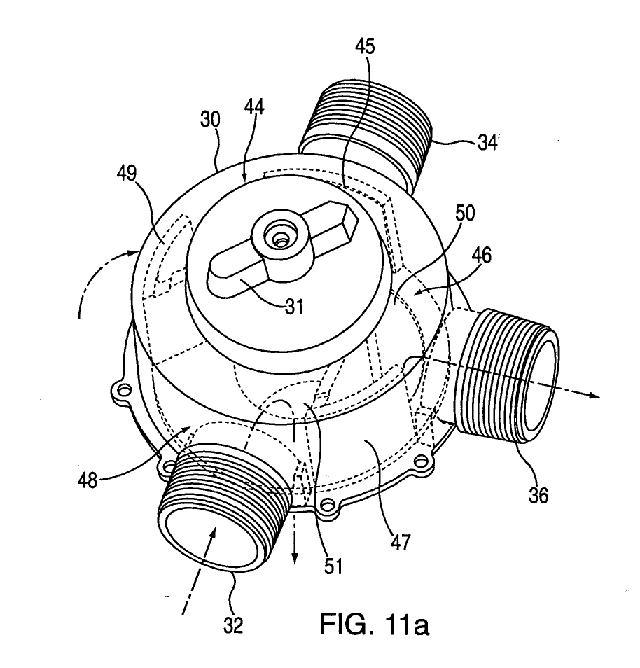

In a third (rinse) position shown in FIGS. 11 and 11a, the diverter 38 is rotated via control knob 31 so that the discontinuity 48 is aligned with pump inlet 32. In this position, the cylinder segment 45 blocks the pond return coupling 34 and the discontinuity 46 is aligned with the waste water coupling 34. In this position, water flows as described above with respect to the filter position but out to the waste water coupling 36 rather than to the pond return coupling 34.

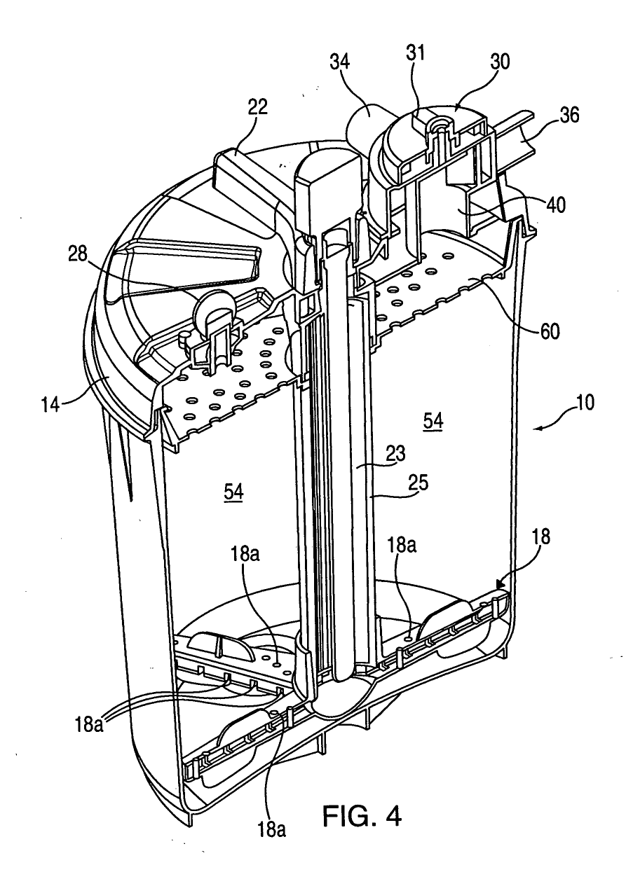

When the valve is set to the backwash position, filter media is prevented from being expelled by a screen 60 (seen best in FIG. 4). In the filter mode, the screen 60 helps to evenly distribute water over the filter media. As mentioned above, when the valve is in the backwash position, the agitator 18 is preferably rotated back and forth as shown in FIG. 3 by moving the handle 22. This serves to release captured debris from the filter media so as to obtain an evenly distributed flow of water through the filter media. Simply backwashing the filter does not move dead or clogged areas in the filter; i.e., some water flows through the filter but “dead” or clogged areas remain producing a so-called undesirable “channeling” of the filter water. Agitating the media in the backwash and rinse modes will keep the filter from clogging.

There have been described and illustrated herein an embodiment of a filter assembly for a pond. While a particular embodiment of the invention has been described, it is not intended that the invention be limited thereto, as it is intended that the invention be as broad in scope as the art will allow and that the specification be read likewise. For example, although the water filter of the present application is especially intended for pond applications, it may be suitable for use in connection with swimming pools, spas or other filtration applications. It will therefore be appreciated by those skilled in the art that yet other modifications could be made to the provided invention without deviating from its spirit and scope as so claimed.

1. A filter assembly, comprising:
a container for containing filter media, and
a three way valve coupled to said container,
said three way valve having a water inlet, a water outlet, a waste water outlet, and a flow diverter,
said flow diverter being movable to a filter position, in which water from a body of water is fed via said water inlet through said container in a first direction to effect filtering of said water and back to said water outlet for return to said body of water, a rinse position, in which water from a body of water is fed via said water inlet through said container in said first direction to effect filtering of said water and back to said waste water outlet for removal from said body of water, and a backwash position, in which water from a body of water is fed via said water inlet through said container in a reverse direction to said first direction to effect backwashing of said filter media and back to said waste water outlet for removal from said body of water.

2. The filter assembly according to claim 1, wherein:
the flow diverter has means for diverting water both horizontally and vertically.

3. The filter assembly according to claim 1, further comprising:
a manually operable agitator located in said container and coupled to a handle outside said container.

4. The filter assembly according to claim 3, further comprising:
a UV sterilizer coupled to said agitator and said handle.

5. The filter assembly according to claim 2, wherein:
said flow diverter includes a discontinuous cylinder.

6. A filter assembly, comprising:
a container for containing filter media, and
a three way valve,
said three way valve having a water inlet, a water outlet, a waste water outlet, and a flow diverter, wherein
said flow diverter includes a discontinuous cylinder.

7. The filter assembly according to claim 6, wherein:
the flow diverter has means for diverting water both horizontally and vertically.

8. The filter assembly according to claim 6, further comprising:
a manually operable agitator located in said container and coupled to a handle outside said container.

9. The filter assembly according to claim 8, further comprising:
a UV sterilizer coupled to said agitator and said handle.

10. A filter assembly, comprising:
a container for containing filter media, and
a three way valve,
said three way valve having a water inlet, a water outlet, a waste water outlet, and a flow diverter, wherein
said flow diverter has means for diverting water both horizontally and vertically.

11. The filter assembly according to claim 10, further comprising:
a manually operable agitator located in said container and coupled to a handle outside said container.

12. The filter assembly according to claim 11, further comprising:
a UV sterilizer coupled to said agitator and said handle.

13. A filter assembly, comprising:
a substantially cylindrical container for holding filter media, said container having a central axis;
an agitator assembly having an axis of rotation substantially coaxial with said central axis; and
a removable cover, said removable cover having a handle, said handle being coupled to said agitator for rotating said agitator assembly about said axis of rotation thereof in a reciprocating manner.

14. The filter assembly according to claim 13, further comprising:
a UV sterilizer, said UV sterilizer being arranged substantially coaxial with said central axis,
filter media disposed in said container above said agitator; and
a three way valve coupled to said cover.

15. The filter assembly according to claim 14, wherein:
said UV sterilizer is coupled to said agitator and said handle.

16. The filter assembly according to claim 15, wherein:
said UV sterilizer has an outer tube and an inner UV lamp defining an annular fluid flow path.

17. A three way valve for use with a water filter, said valve comprising:
a water inlet,
a water outlet,
a waste water outlet, and
a flow diverter, said flow diverter having means for diverting the flow of water both horizontally and vertically.

18. The valve according to claim 17, wherein:
said flow diverter includes a discontinuous cylinder.

19. The valve according to claim 18, wherein:
said discontinuous cylinder is defined by three cylinder segments.

20. The valve according to claim 19, wherein:
said flow diverter has three fluid pathways defined by said three cylinder segments and a fourth fluid pathway substantially perpendicular to said three fluid pathways.
